(19) United States
(12) Patent Application Publication
(10) Pub. No.: US 2023/0070890 A1
(43) Pub. Date: Mar. 9, 2023

(54) CABLE CONNECTOR SYSTEM

(71) Applicant: Samtec, Inc., New Albany, IN (US)

(72) Inventor: Andrew S. SHROUT, New Albany, IN (US)

(21) Appl. No.: 17/796,353

(22) PCT Filed: Mar. 12, 2021
(86) PCT No.: PCT/US2021/022034

§ 371 Date: Jul. 29, 2022

Related U.S. Application Data
(60) Provisional application No. 63/053,150, filed on Jul. 17, 2020.
(60) Provisional application No. 62/704,073, filed on Mar. 13, 2020.

(51) Int. Cl. H01R 13/6581; H01R 13/66

(52) U.S. Cl. CPC H01R 13/6581; H01R 13/6658

(57) ABSTRACT

A cable assembly includes a first connector that includes a first connector housing, at least two connector conductors and at least two signal conductors included in the first connector housing, at least two connector cable conductors that are each physically connected to a respective one of the at least two connector conductors, at least two signal cable conductors each physically connected to a respective one of the at least two signal conductors, a substrate, and a memory module mounted to the substrate. The substrate and the memory module are either spaced away from the first connector or connected to a conductor in the first connector housing through an opening in the first corrector housing.

### CROSS REFERENCE TO RELATED APPLICATIONS

The entire contents of U.S. Patent Application No. 62/704,073, filed on Mar. 13, 2020; U.S. Patent Application No. 63/053,150, filed on Jul. 17, 2020; and U.S. patent application Ser. No. 29/632,520, filed on Jan. 8, 2018, are hereby incorporated by reference.

### BACKGROUND OF THE INVENTION

### 1. Field of the Invention

The present invention relates to cable connector systems. More specifically, the present invention relates to a cable connector system that includes an EEPROM (electronically erasable programmable read-only memory) that is able to be provided in-line with a cable or that is insertable into a housing of an electrical connector.

### 2. Description of the Related Art

FIG. 1 is a side perspective view of a known paddle card connector 2 that is matable with a paddle card 1. An EEPROM module is known to be used on the paddle card connector 2, for example, a QSFP (quad small form-factor pluggable) transceiver. Furthermore, although conventional electrical connectors and cables have been known to include active or passive signal conditioning components, memory modules such as EEPROM modules have not previously been included in-line with signal cables such as twin axial cables. A twin axial cable is an electrical cable that includes two conductors surrounded by a dielectric, with the dielectric surrounded by a shield layer. In addition, memory modules, such as EEPROM modules, have not previously been insertable into a housing of an electrical connector.

Some conventional electrical connectors include a transition substrate or circuit board with circuitry. The circuitry can condition the electrical signals transmitted by the electrical connectors.

### SUMMARY OF THE INVENTION

To overcome the problems described above, embodiments of the present invention provide cable connector systems with in-line memory modules and memory modules inserted into a housing of an electrical connector of the cable connector systems. In particular, embodiments of the present invention are able to provide a memory module, for example, an EEPROM module, that is in-line with signal and power cables. In addition, embodiments of the present invention are also able to provide a memory module, for example, an EEPROM module, that is inserted into a housing of an electrical connector of the cable connector systems.

A cable assembly according to an embodiment of the present invention includes a first connector that includes a first connector housing, at least two connector conductors and at least two signal conductors included in the first connector housing, at least two connector cable conductors that are each physically connected to a respective one of the at least two connector conductors, at least two signal cable conductors each physically connected to a respective one of the at least two signal conductors, a substrate, and a memory module mounted to the substrate. The substrate and the memory module are both spaced away from the first connector, and the at least two signal cable conductors are each physically connected to the substrate.

The memory module may include an EEPROM (electronically erasable programmable read-only memory). The at least two signal cable conductors may be at least partially surrounded by a ground shield layer. The ground shield layer may be directly connected to a ground connection of the substrate. Each of the at least two signal cable conductors may not be electrically connected to ground. The first connector may include no substrate or circuit board. The memory module can be located outside of the first connector housing and can be spaced away from the first connector housing. The memory module is not physically connected to any of the at least two connector conductors and the at least two signal conductors.

The at least two signal cable conductors may include (1) at least three signal cable conductors that are each physically attached to the substrate, (2) at least four signal cable conductors that are each physically attached to the substrate, (3) at least five signal cable conductors that are each physically attached to the substrate, or (4) at least six signal cable conductors that are each physically attached to the substrate.

The cable assembly may further include a second connector connected to respective ends of the at least two connector cable conductors and of the at least two signal cable conductors that are opposite to the ends of the at least two connector cable conductors and of the at least two signal cable conductors connected to the first connector. One of the at least two signal cable connectors may be a ground conductor, and the memory module may be not physically connected to the ground conductor. Each of the at least two signal cable conductors may be terminated at the substrate.

A cable assembly according to an embodiment of the present invention includes a first connector including a first contact and a second contact, a second connector including a first contact and a second contact, a substrate spaced away from the first and the second connectors, a memory module mounted to the substrate, a first cable physically connected to the first contact of the first connector and physically connected to the first contact of the second connector, and a second cable physically connected to the second contact of the first connector and physically connected to the substrate.

The second cable may terminate at the substrate and may be not connected to the second contact of the second connector. The first and the second cables may be twin axial cables. The cable assembly may further include third and fourth cables that are physically connected to the second connector and the substrate. The third and the fourth cables may be not connected to the second connector. The memory module include an EEPROM.

An assembly according to an embodiment of the present invention includes a host substrate, a third connector mounted to the host substrate, and the cable assembly according to one of the various embodiments of the present invention. The first connector can mate and unmate with the third connector. When the first and the third connectors mate, the memory module may transmit information to the host substrate through the second cable.

According to an embodiment of the present invention, a cable assembly includes a first connector that includes a connector housing, first and second conductors included in the connector housing, a cable connected to the first conductor, and a memory device connected to the second conductor through an opening in the connector housing.

The memory device can include an EEPROM (electronically erasable programmable read-only memory). The memory device can connect to and disconnect from the connector housing. When the memory device is connected to the connector housing, the memory device can be in a pocket defined in an exterior wall of the connector housing.

The opening can be defined by a slit that receives a terminal of the memory device. The first connector does not have include a substrate or a circuit board but can include the memory device. The memory device can at least partially be covered by the connector housing. The cable assembly can further include a second connector connected to a respective end of the cable that is opposite to an end of the cable connected to the first connector. The memory device can be directly connected to a side of the second conductor. The opening can define a surface that extends in a direction parallel or substantially parallel to a mating direction of the first connector. The second conductor can include a planar or substantially planar surface to which the memory device is connected.

The cable assembly can further include a third conductor included in the connector housing, wherein the memory device can be connected to the third conductor through the opening in the connector housing. The cable assembly can further include a fourth conductor included in the connector housing, wherein the memory device can be connected to the fourth conductor through the opening in the connector housing. The cable assembly can further include a fifth conductor included in the connector housing, wherein the memory device can be connected to the fifth conductor through the opening in the connector housing. The cable assembly can further include a sixth conductor included in the connector housing, wherein the memory device can be connected to the sixth conductor through the opening in the connector housing. The cable assembly can further include a seventh conductor included in the connector housing, wherein the memory device can be connected to the seventh conductor through the opening in the connector housing.

The memory device can include a terminal that extends from the memory device into an interior of the housing. The terminal can connect the memory device to the second conductor.

According to an embodiment of the present invention, an assembly includes a host substrate, a third connector mounted to the host substrate, and the cable assembly of one of the various embodiments of the present invention. The first connector can mate and unmate with the third connector.

When the first and the third connectors mate, the memory module can transmit information to the host substrate through the second conductor.

According to an embodiment of the present invention, a wafer includes a signal conductor and a memory device connected to the signal conductor.

The memory device can be directly connected to the signal conductor but is not in-line with the signal conductor. The wafer can further include a ground plate, wherein the memory device can be attached to the ground plate.

According to an embodiment of the present invention, a connector includes a housing with a pocket and the wafer of one of the various embodiments of the present invention in the housing such that the memory device is in the pocket.

The housing can include a slit through which the memory device is connected to the signal conductor. The connector can further include a cable connected to the wafer.

According to an embodiment of the present invention, a cable assembly includes the connector of one of the various embodiments of the present invention and an additional connector connected to a respective end of the cable that is opposite to an end of the cable connected to the wafer.

According to an embodiment of the present invention, an assembly includes a host substrate, a second additional connector mounted to the host substrate, and the cable assembly of one of the various embodiments of the present invention. The connector can mate and unmate with the second additional connector.

When the connector and the second additional connector mate, the memory device can transmit information to the host substrate through the signal conductor.

The above and other features, elements, steps, configurations, characteristics, and advantages of the present invention will become more apparent from the following detailed description of the embodiments of the present invention with reference to the attached drawings.

### BRIEF DESCRIPTION OF THE DRAWINGS

FIG. 1 is a side perspective view of a known paddle card connector.

FIG. 2 is a perspective view of a cable connector system with an EEPROM in-line with a cable.

FIG. 3 is a close-up perspective view of the cable connector system shown in FIG. 2.

FIG. 4 is a top perspective view of the cable connector system shown in FIG. 2 prior to an upper cable connector being inserted into a lower connector.

FIG. 5 is a bottom perspective view of the cable connector system shown in FIG. 2 prior to the upper cable connector being inserted into the lower connector.

FIG. 6 is a front view of the cable connector system shown in FIG. 2 prior to the upper cable connector being inserted into the lower connector, with the housings of the upper and lower connectors removed for clarity.

FIG. 7 is a rear view of the cable connector system shown in FIG. 2 prior to the upper cable connector being inserted into the lower connector, with the housings of the upper and lower connectors removed for clarity.

FIG. 8 is a perspective view of a single wafer of the cable connector system shown in FIG. 2, with the housings of the upper and lower connectors and the memory housing removed for clarity.

FIG. 9 is a bottom view of a memory device of the cable connector system shown in FIG. 2, with the memory housing removed for clarity.

FIG. 10 is a top view of the memory device of the cable connector system shown in FIG. 2, with the memory housing removed for clarity.

FIG. 11 is a circuit diagram of one implementation of the memory module.

FIG. 12 is a perspective view of a cable connector system with an EEPROM in the housing of a cable connector.

FIG. 13 is a close-up perspective view of the cable connector system shown in FIG. 12.

FIG. 14 is a top perspective view of the cable connector system shown in FIG. 12 prior to an upper cable connector being inserted into a lower connector.

FIG. 15 is a bottom perspective view of the cable connector system shown in FIG. 12 prior to the upper cable connector being inserted into the lower connector.

FIG. 16 is a close-up in view of the cable connector system shown in FIG. 12 with a portion of the housing removed.

FIG. 17 is a bottom perspective view of a memory device that can be used with the cable connector system shown in FIG. 12.

FIG. 18 is a perspective view of wafers that can be used with the upper cable connector.

FIGS. 19A and 19B are perspective views of the memory device being inserted into the housing of the upper cable connector, with the wafers of the cable connector system removed for clarity.

FIGS. 20A and 20B are perspective views of a single wafer with a memory device that can be used with the cable connector system shown in FIG. 12.

FIG. 21 is a top view of the memory device of the cable connector system shown in FIG. 12.

FIGS. 22-24 are perspective views of the cable connector system with a clip added to secure the upper cable connector to the lower connector.

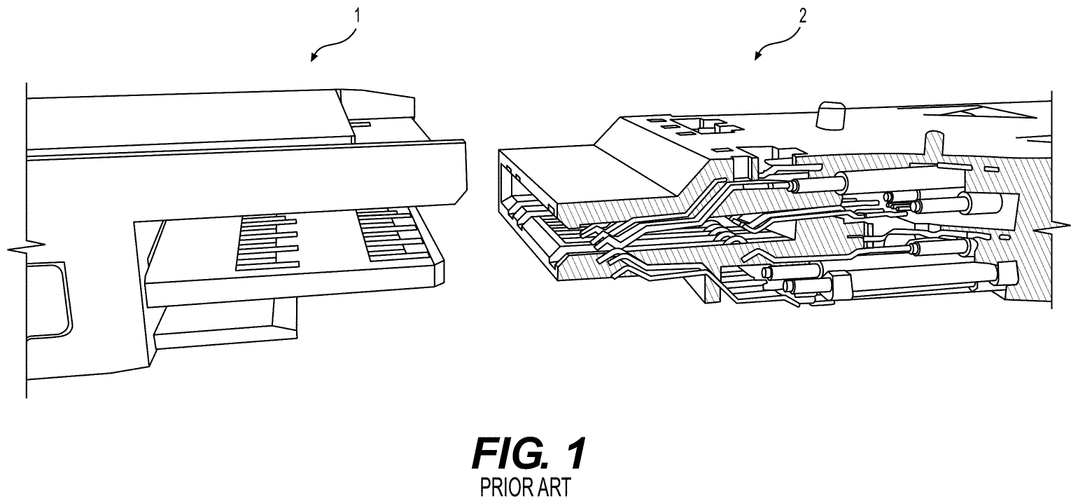

### DETAILED DESCRIPTION

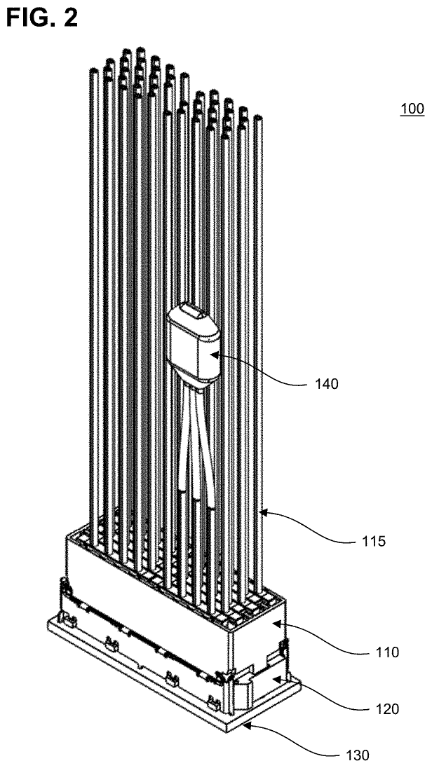

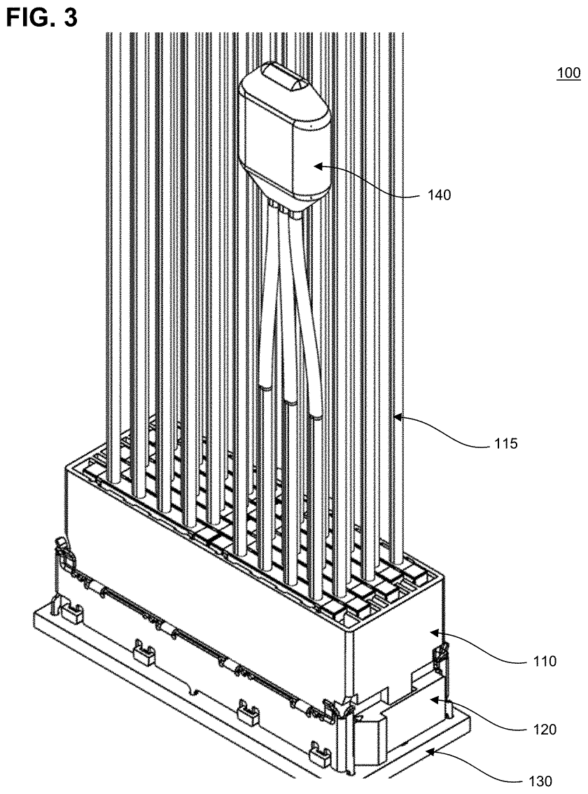

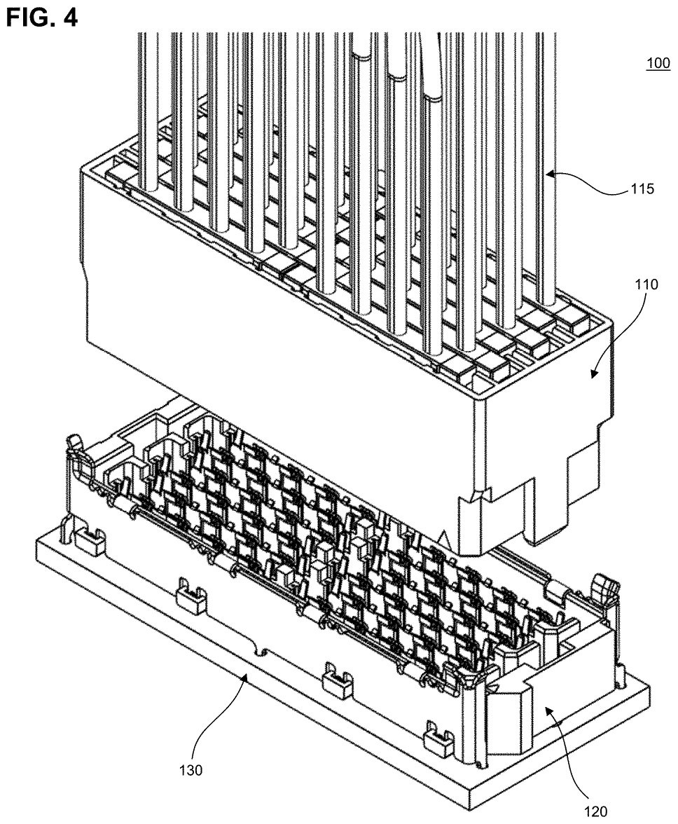

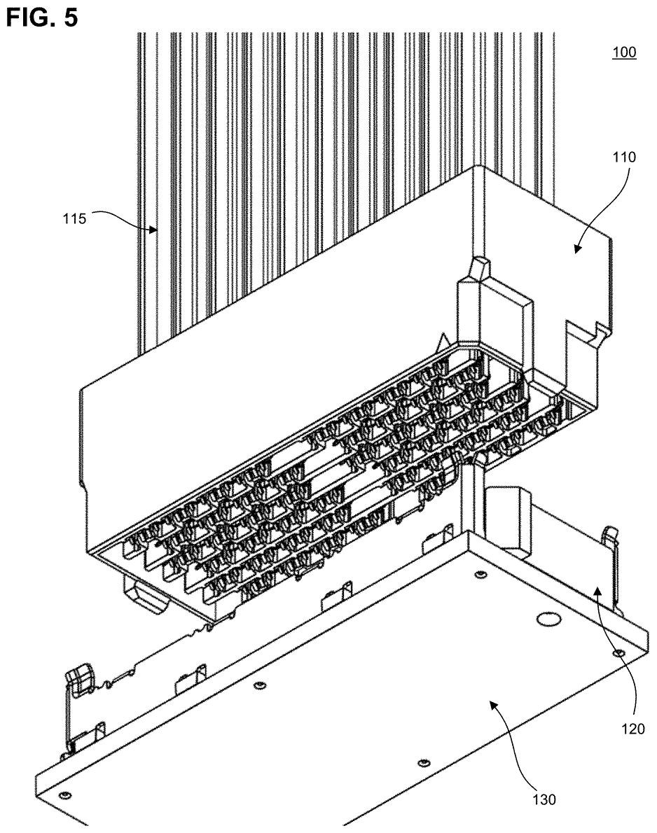

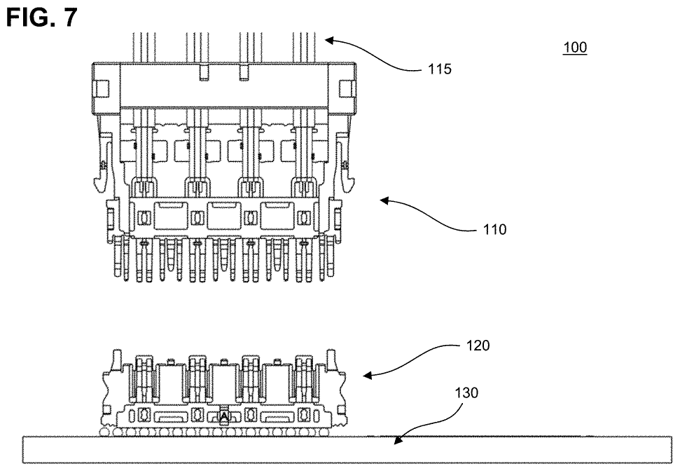

Embodiments of the present invention will now be described in detail with reference to FIGS. 2-24. Note that the following description is in all aspects illustrative and not restrictive and should not be construed to restrict the applications or uses of the present invention in any manner.

FIGS. 2-10 show a cable connector system 100. As shown in FIGS. 2-5, the cable connector system 100 includes a cable assembly with an upper (or first) cable connector 110 and a lower (or second) connector 120. The upper cable connector 110 and the lower connector 120 can be any suitable connector and can be connectors without a printed circuit board (PCB) or other substrate and without any active components. The lower connector 120 can be mounted to a connector substrate 130, such as a PCB or other suitable substrate.

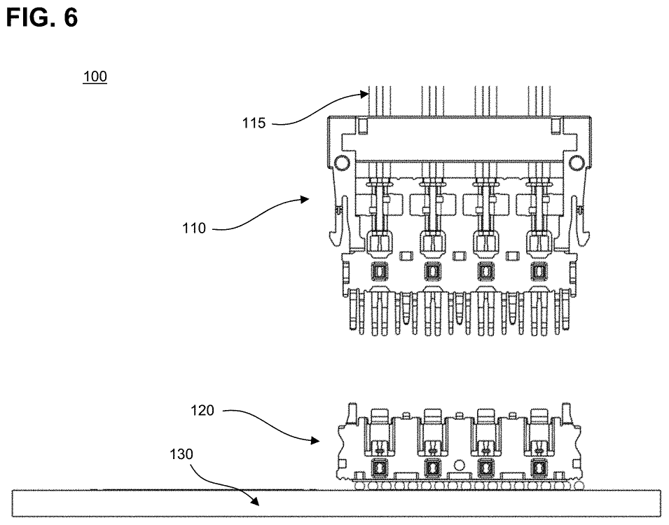

A plurality of cables 115 are attached to, and terminated by, the upper cable connector 110. The cables 115 can be, for example, co-extruded twin axial signal cables in which the same dielectric material encloses both cable conductors 116 in the cables, which allows differential signals to be transmitted. Alternatively, a pair of coaxial cables can be used instead of a twin axial cable. At least a portion of the cables 115 electrically transmit signals (for example, data signals and/or clock signals) and/or power to the upper cable connector 110 and the lower connector 120. A memory device 140 can be connected to some of the cables 115. As shown in FIGS. 6-8, individual electrical connections are provided between the upper cable connector 110 and the lower connector 120 for each individual cable conductor 116 of each of the co-extruded twin axial cables 115.

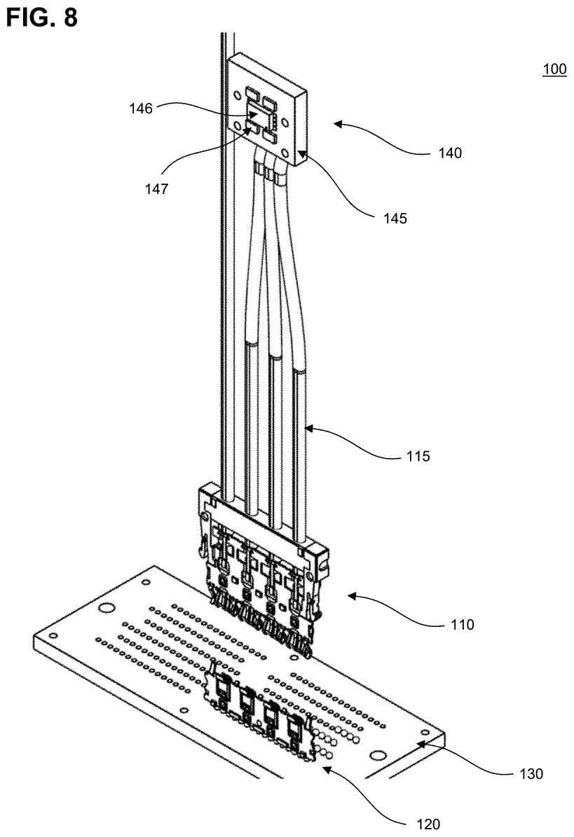

As shown in FIGS. 8-10, at least one of the co-extruded twin axial cables 115 is directly connected to a memory substrate 145 of a memory device 140. For example, twinaxial cable conductors 116 may be directly soldered to corresponding terminal pads of the memory substrate 145. However, other electrical connections may be used. In addition, a shield layer of the cable 115 directly connected to the memory substrate 145 can be directly attached to a ground connection 148 of the memory substrate 145, for example.

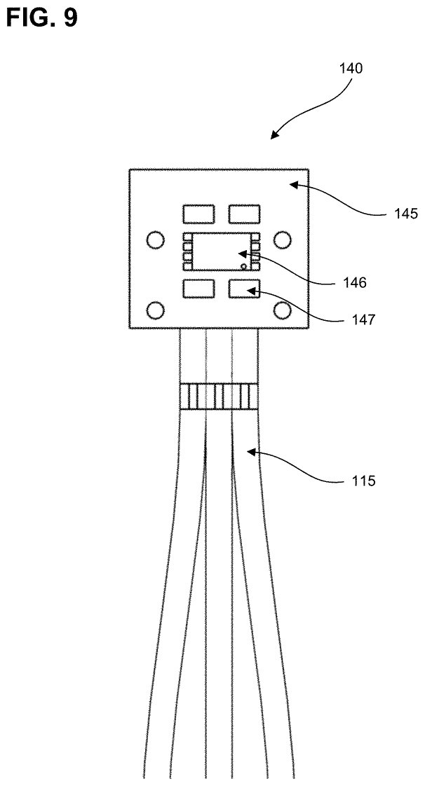

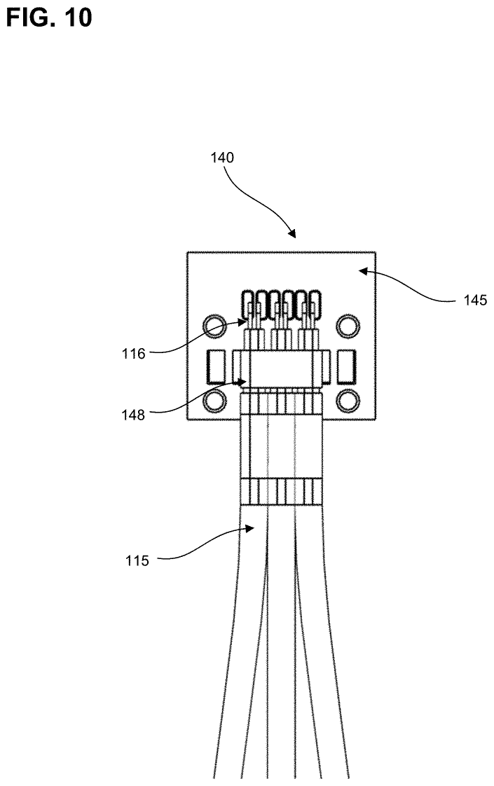

As shown in FIGS. 8 and 9, a memory module 146, for example, an EEPROM is mounted to the memory substrate 145. The memory substrate 145 and the memory module 146 mounted thereon can be physically supported only by the co-extruded twin axial signal cable 115. As shown in FIGS. 9 and 10, the cable 115 directly connected to the memory substrate 145 can be attached to a side of the memory substrate 145 that is opposite to a side of the substrate on which the memory module 146 is mounted.

FIGS. 8 and 9 also shows that additional components, such as circuit elements 147, may be mounted to the memory substrate. For example, these additional components may be surface-mount capacitor(s), surface-mount resistor(s), and the like. Other components may be provided in addition to, or in place of, the circuit elements. Such additional components can be passive surface-mounted components, for example, a surface-mount inductor.

As shown in FIGS. 2, 3, and 8-10, the memory device 140 can be spaced away from the upper cable connector 110. For example, the memory device 140 and the upper cable connector 110 may be separated from each other by a distance of about two inches, although other separations are possible.

The memory substrate 145 and the memory module 146 can be covered by a housing or the like to provide increased durability. For example, the memory substrate 145 and the memory module 146 may be overmolded or covered with heat-shrink tubing. In addition, a sleeve may be placed over the memory device 140 and around the cables 115, for example, to provide increased durability and to secure the memory device 140 within the cable connector system 100. The sleeve may be, for example, a polyester braided sleeve.

The EEPROM can include firmware and can store identification information and/or authentication information. For example, the identification information may be an initiation code and/or may enable a system connected to the connector substrate to detect when the upper cable connector 110 is plugged into the lower connector 120. More specifically, the identification information may be information regarding the type of cable 115 attached to the upper cable connector 110, and may also include a unique identifier such as a serial number or other similar information.

As shown in FIG. 10, three twinaxial cables 115 with six total twinaxial cable conductors 116 can be directly connected to the memory substrate. For example, at least three, at least four, at least five, or at least six cable conductors 116 can be directly connected to the memory substrate 145. Two of the twinaxial cable conductors 116 may be provided to supply power to the memory device 140, and four of the twinaxial cable conductors 116 may be provided to transfer signals to and from the memory device 140. For example, two of the twinaxial cable conductors 116 may receive signals from a device connected to the memory substrate 145, and two of the twinaxial cable conductors 116 may transmit signals to the device connected to the memory substrate 145. As noted above, shield layers of the twinaxial cables 115 can be directly attached to a ground connection 148 of the memory substrate 145.

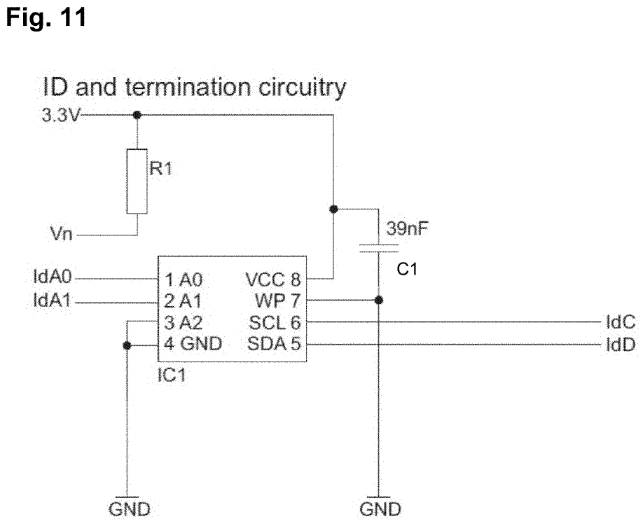

FIG. 11 is a circuit diagram of one implementation of the memory module 146. FIG. 11 shows an EEPROM IC1 connected to a voltage supply of 3.3 V, a reference voltage Vn, ground GND, and four signal lines IdA0, IdA1, IdC, and IdD. The signal lines IdA0, IdA1 can be connected to a first twinaxial cable, and the signal lines IdC, IdD can be connected to a second twinaxial cable. A third twinaxial cable includes at least one conductor that provides the 3.3 V voltage supply, and both conductors of the third twinaxial cable may provide the 3.3 V voltage supply to increase current capacity and to reduce thermal load. Thus, as shown in FIG. 11, pins 1 and 2 (A0 and A1) of the EEPROM IC1 are connected to the first twinaxial cable; pins 5 and 6 (SDA and SCL) of the EEPROM IC1 are connected to the second twinaxial cable; pin 8 (VCC) is connected to the third twinaxial cable; and pins 3, 4, and 7 (A2, GND, and WP) of the EEPROM IC1 are connected to ground.

The reference voltage Vn may be a ground reference or a neutral reference. Resistor R1 is connected between the 3.3 V voltage supply and the reference voltage Vn to provide circuit fault protection. Capacitor C1 is connected between the 3.3 V voltage supply to reduce the noise and stabilize the power supplied to the EEPROM IC1. The memory substrate can include a ground that is connected to the shield of the twinaxial cables and that provides ground GND for the circuitry shown in FIG. 11. It is noted that the values shown in FIG. 11 are only provided as examples, and the number of signal lines connected to the EEPROM IC1 may be changed. The resistor R1 and the capacitor C1 may correspond to one or more of the circuit elements 147 shown in FIG. 9.

As shown in FIGS. 2-5, the upper cable connector 110 and the lower cable connector 120 may house a plurality of signal cables 115. For example, each of the upper cable connector 110 and the lower cable connector 120 may include six rows of signal cables 115 that are separated into two banks, thereby providing 96 separate electrical connections by 48 pairs of twin axial cables 115. However, for example, three of the 48 pairs of twin axial cables 115 may be directly connected to the EEPROM, and the remaining 45 pairs of twin axial cables 115 may be used to transmit signals (for example, data signals and/or clock signals) and/or power. This implementation may provide performance of up to, for example, 112G PAM4 (i.e., a line data rate of 112 Gb/s using pulse amplitude modulation with four levels).

As shown in FIGS. 2, 3, and 8-10, the cables 115 connected to the memory substrate can terminate at the memory substrate. However, one or more of the cables 115 may be spliced to provide a pass-through connection. For example, a cable conductor 116 that provides power to the memory substrate may be spliced to additionally provide power to another device.

Although twinaxial cables have been described above, other types of cables may be used as the cables 115. For example, coaxial cables, parallel coaxial cables with drain wires, and other types of cables may be directly connected to the memory module 146.

As shown in FIGS. 2-8, a first end of each of the cables 115 of the cable assembly is terminated at the upper cable connector 110. A second end of each of the cables 115 may also be terminated to a similar cable connector. A second memory device may be provided at the second end of the cables 115, at a similar distance from the similar cable connector as the first memory device 140 is from the upper cable connector 110. The second memory device may include similar cable connections to a second upper cable connector as the upper cable connector 110 described above. However, if the second memory device is not included, the corresponding contacts in a second upper cable connector (and corresponding lower connector) may be left as not connected or may be connected to ground.

Examples of other cable connectors that may be provided at the second end of the cables 115 include an EXAMAX® connector (for example, an EXAMAX® Backplane Cable Header (e.g., Samtec, Inc. series number EBCM)); a NOVARAY two-bank four row cable connector (for example, as shown in EU RCD 005469509-0001, the contents of which are incorporated herein in their entirety); a quad small form factor pluggable (QSFP) connector; an ACCELERATE connector (for example, an 0.635 mm ACCELERATE Slim Cable Assembly (e.g., Samtec, Inc. series number ARC6)); a FLYOVER QSFP (e.g., Samtec, Inc. series number FQSFP) connector (for example, as described in U.S. 2019/0181570 A1, the contents of which are incorporated herein in their entirety); a NVAM® cable connector such as the one shown in U.S. application Ser. No. 29/632,520; a PCIe (peripheral component interconnect express) connector; one of the electrical connectors disclosed in PCT Application No. PCT/US2019/055139, the contents of which are incorporated herein in their entirety; one of the electrical connectors described in U.S. 2019/0267732, the contents of which are incorporated herein in their entirety); or a FIREFLY connector (for example, a FIREFLY copper connector (e.g., Samtec, Inc. series number ECUE).

A cable assembly can include a memory device that is spaced away from the upper cable connector 110. By providing the memory device outside of a first connector housing of the upper cable connector 110, the cable assembly is able to be easily implemented in various systems, while also being manufactured with reduced costs. In addition, the memory device 140 can be easily implemented with other types of cables, and existing cabling and connectors can be easily modified to include the memory device 140. The memory device 140 can be physically accessed, repaired, or replaced without destroying, damaging, or disturbing the upper cable connector 110 or the first connector housing. The memory device 140 can be physically accessed, repaired, or replaced or without removing or disturbing potting material, connector housing overmold material, or sealing material from the connector housing of the upper cable connector 110 or the cables 115. The memory device 140 can be positioned external to the connector housing, i.e. the connector housing can define at least four joined walls, and the memory device 140 can be positioned outside all of the four joined walls of the connector housing.

Thus, an electrical connector can be provided with a memory device, but without requiring a paddle card or transition substrate within the body of the connector (e.g., a transition circuit board).

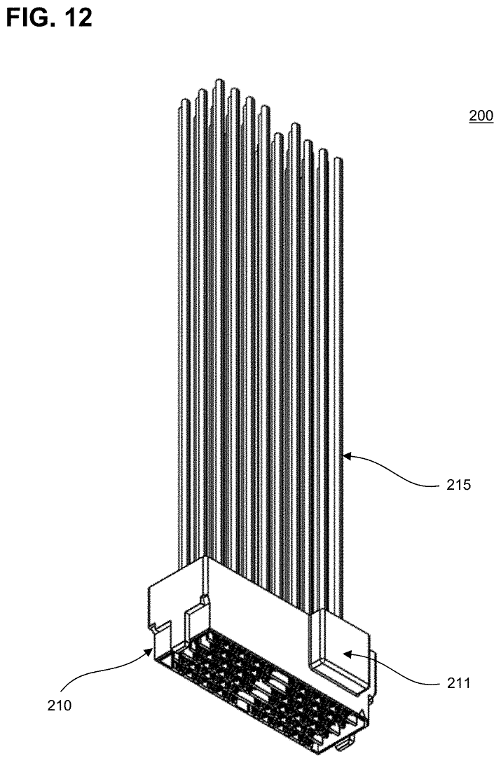

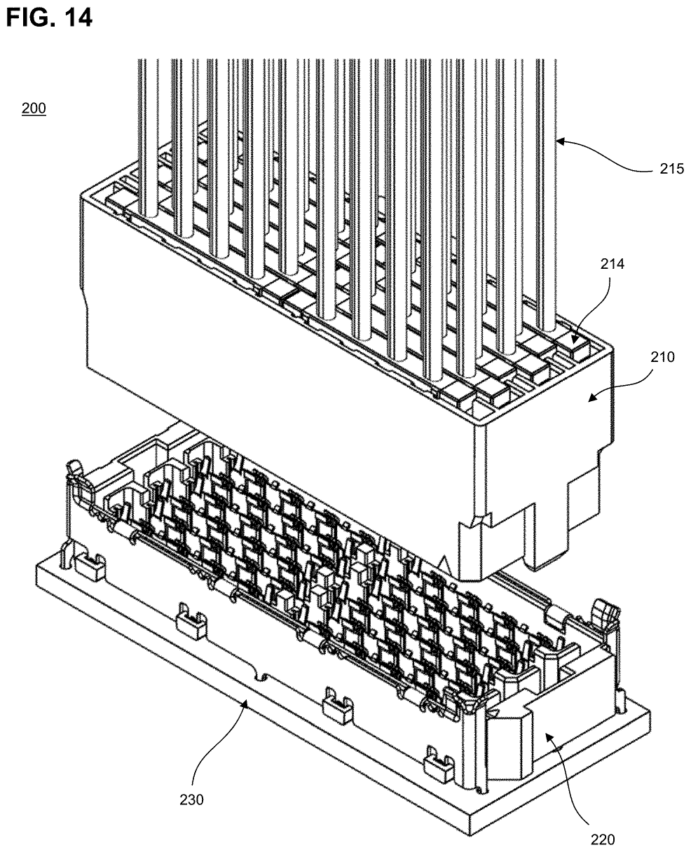

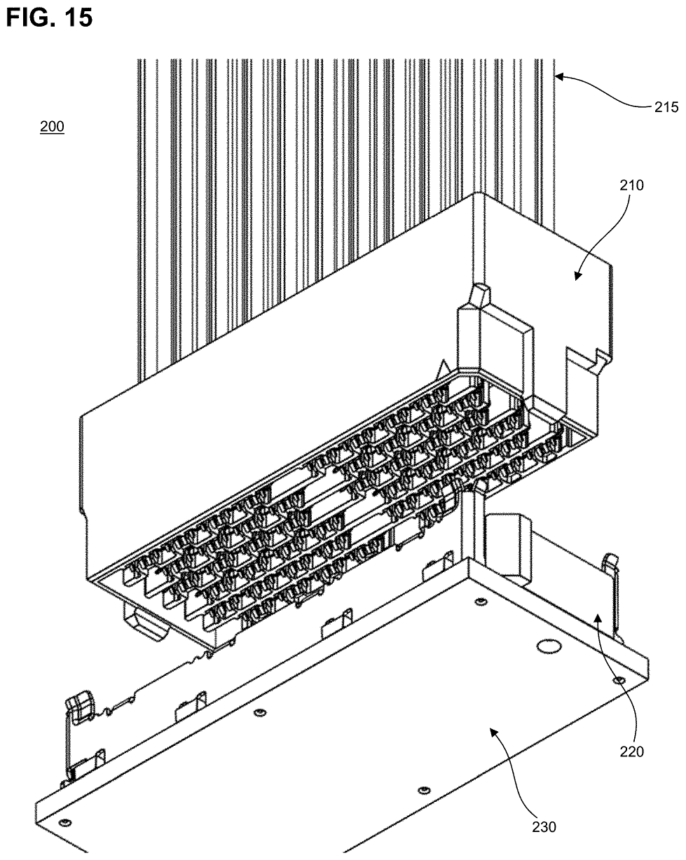

FIGS. 12-21 show a cable connector system 200. As shown in FIGS. 12-16, the cable connector system 200 includes a cable assembly with an upper (or first) cable connector 210 and a lower (or second) connector 220. The upper and lower connectors 210 and 220 can be any suitable connectors and can be connectors without a printed circuit board (PCB) and without any active components. The lower connector 220 can be mounted to a connector substrate 230, such as a PCB or other suitable substrate. No memory device is shown in FIGS. 14 and 15, for clarity.

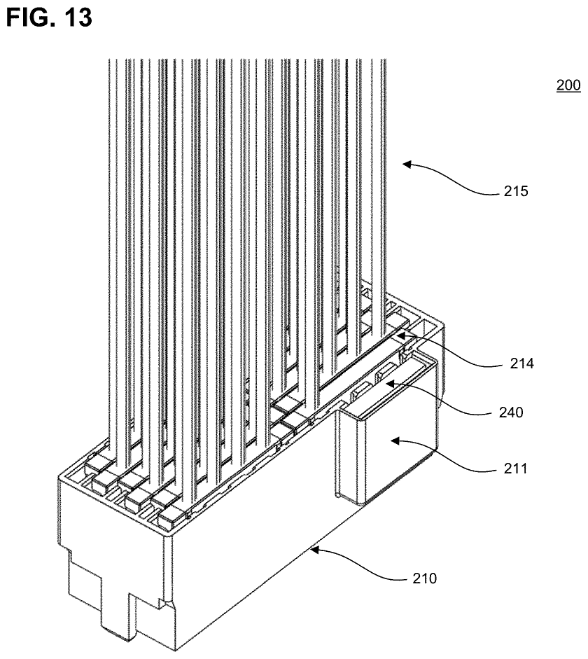

As shown in FIGS. 12 and 13, the housing of the upper cable connector 210 can include a pocket 211 that can receive a memory device 240. The pocket 211 can have any suitable shape and can substantially match within manufacturing tolerances the memory device 240. Although only one pocket 211 is shown, it is possible to include an additional pocket or pockets.

A plurality of cables 215 is attached to, and terminated by, the upper cable connector 210. As shown, for example, in FIG. 13, the cables 215 can be connected to wafers 214. FIG. 12 shows six rows of two wafers 214, i.e., a total of twelve wafers 214, but any arrangement and/or number of wafers can be used. The cables 215 can be, for example, co-extruded twinaxial signal cables in which the same dielectric material encloses both cable conductors in the cables, which allows differential signals to be transmitted. A twinaxial cable is an electrical cable that includes two cable conductors surrounded by a dielectric material, with the dielectric material surrounded by a shield layer. Alternatively, a pair of coaxial cables can be used instead of a twinaxial cable. At least a portion of the cables 215 electrically transmit signals (for example, data signals and/or clock signals) and/or power to the upper cable connector 210 and the lower connector 220. As shown in FIGS. 14-16, 18, 20A, and 20B, individual electrical connections are provided between the upper cable connector 210 and the lower connector 220 for each individual cable conductor of each of the co-extruded twinaxial cables. Memory device 240 can be positioned such that the memory device is not between two immediately adjacent wafers 214, themselves positioned in the first connector housing of the upper cable connector 210.

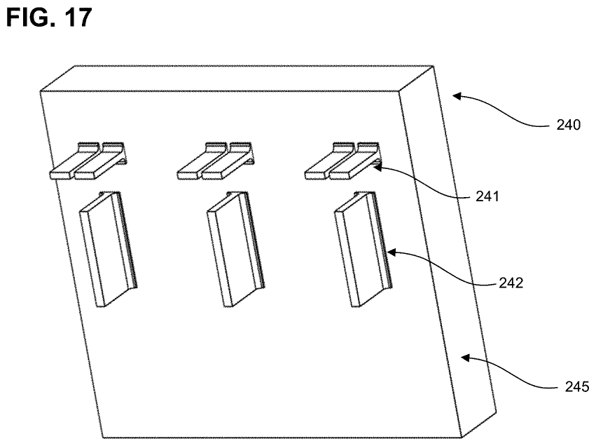

FIG. 17 is a bottom perspective view of a memory device 240 that can be used with the cable connector system 200 shown in FIG. 12. The memory device 240 can be connected to a wafer 214 that can be inserted into the first connector housing of the upper cable connector 210. Any suitable memory device 240 can be used with the cable connector system 200. The memory device 240 can be directly electrically attached to a signal terminal in the wafer 214. As shown in FIG. 17, the memory device 240 can include a substrate 245, signal terminals 241, and ground terminals 242. The arrangement of the signal terminals 241 and the ground terminals 242 depends on the arrangement of the wafers 214 and the cables 215. The signal terminals 241 can have shapes that are planar or substantially planar within manufacturing tolerances and that are aligned or substantially aligned within manufacturing tolerances with one another. The ground terminals 242 can have planar or substantially planar shapes within manufacturing tolerances, and the major planar surfaces of the ground terminals can be perpendicular or substantially perpendicular within manufacturing tolerances to the major planar surfaces of the signal terminals. However, the major planar surfaces of the ground terminals 242 can also be parallel or substantially parallel to the major planar surfaces of the signal terminals 241.

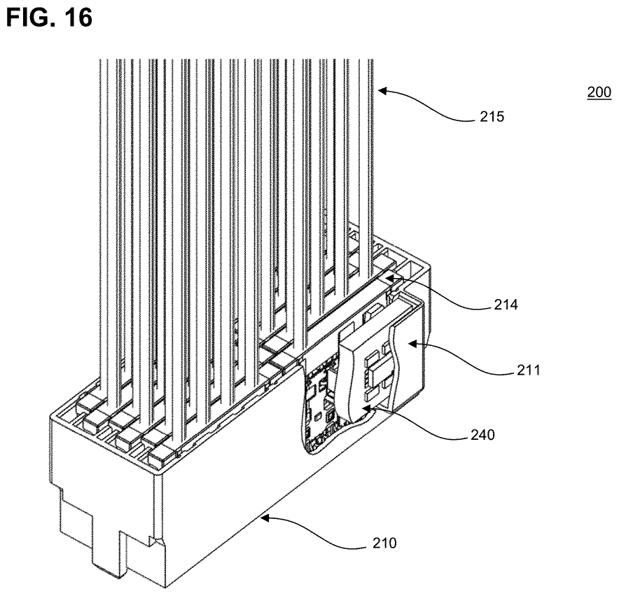

The signal terminals 241 of the memory device 240 can be directly attached to signal terminals within the wafer 214. The signal terminals 241 can be provided in pairs, for example, to correspond to the cable of a twinaxial cable that can be connected to a wafer 214. The ground terminals 242 can be directly connected to the wafer ground terminals 218 on a wafer ground plate 217. Although FIG. 17 shows three pairs of signal terminals 241 and three ground terminals 242, the number of signal terminals 241 and the number of ground terminals 242 is not limited to the example shown in FIG. 17. For example, as shown in FIG. 16, the wafer 214 can include four twinaxial cables, so the memory device 240 can have one to four pairs of single terminals. Each pair of signal terminals 241 can have a corresponding ground terminal 242. But the number of ground terminals 242 can be different from the number of pairs of signal terminals. For example, the memory device 240 can have a single ground terminal 242. The wafer 214 to which the memory device 240 is connected can include one or more twinaxial cable.

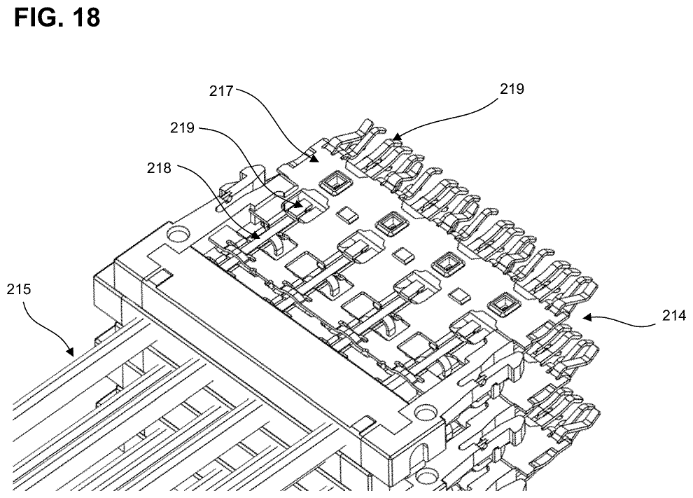

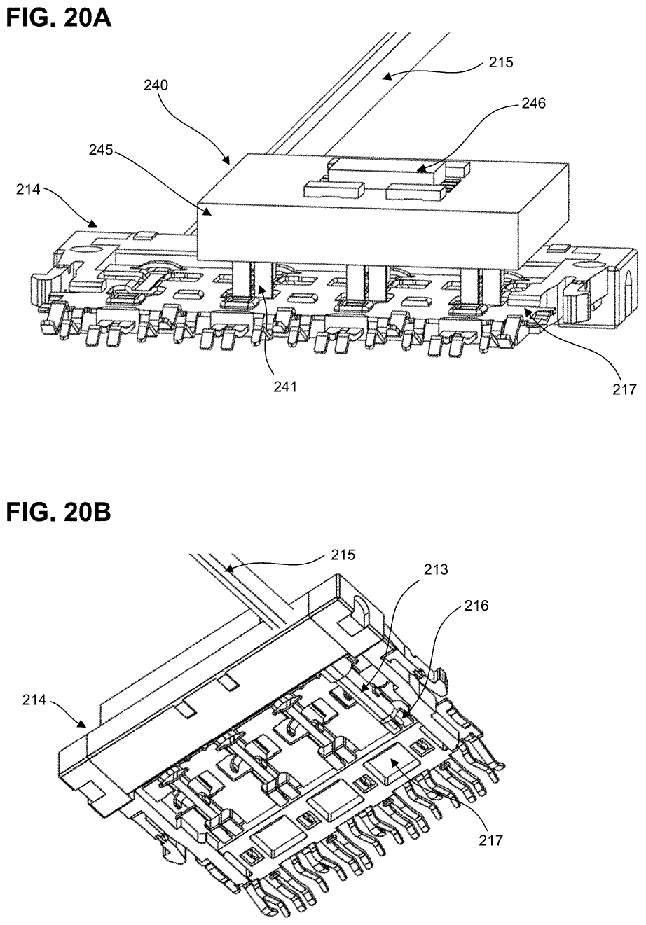

FIG. 18 is a perspective view of the wafers 214 of the upper cable connector 210. The top wafer 214 can include the memory device 240 and only includes a single twinaxial cable. Alternatively, the top wafer 214 can include no twinaxial cables or can include two or more twinaxial cables. In FIG. 18, the connector signal terminals 219 can be seen through holes in the ground plate 217. FIGS. 20A and 20B are, respectively, top and bottom perspective views of a single wafer 214 that can be used with the cable connector system 200. As shown in FIGS. 18 and 20B, a cable 215, for example, a twinaxial cable, is directly connected to a wafer 214 included in the upper cable connector 210. More specifically, cable conductors 216 are directly connected to corresponding signal terminals 219 of the connector, and a ground shield 213 of the cable 215 may be connected to the wafer ground plate 217. For example, the cable conductors 216 of the twinaxial cable may be directly soldered to corresponding signal terminal pads of the upper cable connector 210. However, other electrical connections may be used.

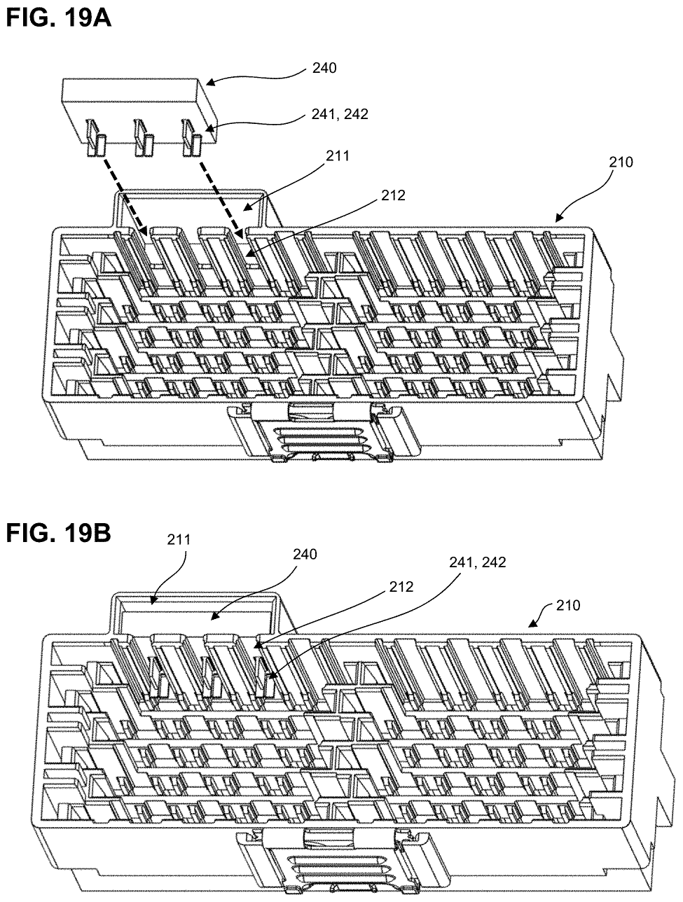

FIGS. 19A and 19B are perspective views of the memory device 240 being inserted into the pocket 211 of the first connector housing of the upper cable connector 210, with the wafers 214 of the cable connector system 200 removed for clarity. As shown in FIGS. 19A and 19B, the first connector housing of the upper cable connector 210 can include slits 212 that receive the signal terminals 241 and ground terminals 242 of the memory device 240. The slits 212 can define openings that define a surface that extends in a mating direction with the lower connector 220 to allow the memory device 240 to be directly or indirectly attached to the terminals of the connector. The slits 212 can be open, e.g., an opening with three sides, as shown in FIGS. 19A and 19B to allow the memory device 240 to be inserted into the pocket 211. The slits 212 can have other arrangements. For example, the slits 212 can be closed, e.g., an opening with four sides. The slits 212 allow the memory device 240 to be attached to the terminals of the connector in a direction that is perpendicular or substantially perpendicular within manufacturing tolerances to the length of the terminals, i.e., parallel or substantially parallel to a major surface to which the connector is connected. Although not shown in FIGS. 19A and 19B, the memory device 240 can be attached to the wafer 214 and then inserted into the connector housing of the upper cable connector 210.

FIGS. 20A and 20B are perspective views of a single wafer 214 of the cable connector system 200 shown in FIG. 12. The signal terminals 241 of the memory device 240 can be electrically connected to corresponding signal terminals of the wafer 214, and the ground terminals 242 can be connected to the wafer ground terminals 218 of the wafer ground plate 217. The memory device 240 can be directly or indirectly connected to a side of the signal terminals. The memory device 240 can be connected to the signal terminals without being in-line with the signal terminals, i.e., for each signal terminal to which the memory device 240 is connected, a line through the signal terminal does not intersect with the memory device 240. In FIG. 20A, the memory device 240 is connected to a broad side, as opposed to the edge, of the signal terminals. The signal terminals can include two opposing broad sides and two opposing edges. The broad sides can include planar or substantially planar surfaces. Although not shown, it is also possible that the memory device 240 can be connected to an edge of the signal terminals.

Two of the signal terminals 241 of the memory device 240 may be provided to supply power to the memory device 240, and four of the signal terminals 241 of the memory device 240 may be provided to transfer signals to and from the memory device 240. For example, two of the signal terminals 241 of the memory device 240 may receive signals from a memory module 246 connected to the memory substrate 245, and two of the signal terminals 241 of the memory device 240 may transmit signals to the memory module 246 connected to the memory substrate 245.

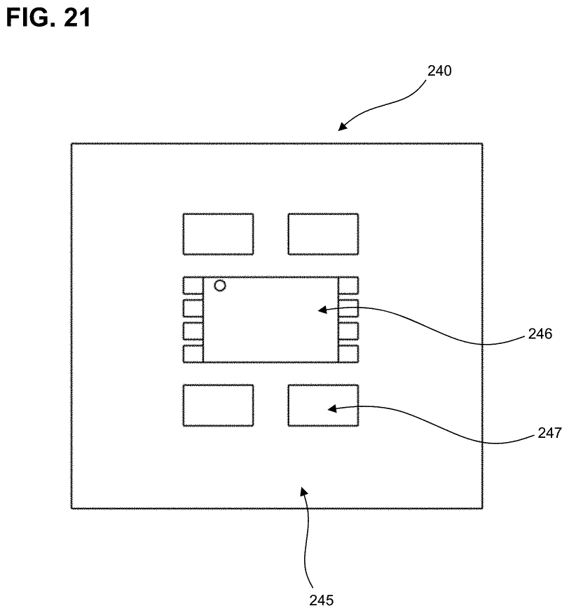

FIG. 21 is a top view of the memory device 240 of the cable connector system 200 shown in FIG. 12. As shown in FIG. 21, a memory module 246, for example, an EEPROM, is mounted to the memory substrate 245. The memory substrate 245 and the memory module 246 mounted thereon can be physically supported only by the first connector housing of the upper cable connector 210. As shown in FIGS. 20A and 20B, the signal terminals 241 and ground terminals 242 of the memory device 240 are attached to a side of the memory substrate 245 that is opposite to a side of the memory substrate 245 on which the memory module 246 is mounted.

FIG. 21 also shows that additional components, such as circuit elements 247, may be mounted to the memory substrate 245. For example, these additional components may be surface-mount capacitor(s), surface-mount resistor(s), and the like. Other components may be provided in addition to, or in place of, the circuit elements 247. Such additional components can be passive surface-mounted components, for example, a surface-mount inductor.

The memory substrate 245 and the memory module 246 can be at least partially covered by a case or the like to provide increased durability, for example, before or during a process of inserting the memory device 240 into the first connector housing of the upper cable connector 210. For example, the memory substrate 245 and the memory module 246 may be inserted into a casing, overmolded, potted, or covered with heat-shrink tubing. The memory device 240 may be inserted into a plastic casing or the like that mates with the pocket 211 of the connector housing. The memory substrate 245 and the memory module 246 may be entirely encapsulated by overmolding or potting, or only a surface of the memory substrate 245 that includes the memory module 246 may be encapsulated by overmolding or potting. If the memory module 246 is covered with heat-shrink tubing, slits may be cut into the heat-shrink tubing to expose the signal terminals 241 and the ground terminals 242 of the memory device 240, and the slits may be cut either before or after the heat-shrink tubing has been shrunk. The memory device 240 can be removably or permanently attached to the upper cable connector 210. If the memory device 240 is removably attached, then the memory device 240 can be connected and can be disconnected from the first connector housing of the upper cable connector 210. If the memory device 240 is permanently attached to the upper cable connector 210, then the memory device 240 can be potted or encapsulated in the pocket 211.

The EEPROM can include firmware and can store identification information and/or authentication information. For example, the identification information may be an initiation code and/or may enable a system connected to the connector substrate 230 to detect when the upper cable connector 210 is plugged into the lower connector 220. More specifically, the identification information may be information regarding the type of cable attached to the upper cable connector 210, and may also include a unique identifier such as a serial number or other similar information.

As shown in FIGS. 13, 14, and 16, four twinaxial cables 215 with eight total twinaxial cable center conductors can be directly connected to each wafer 214 of the upper cable connector 210. For example, at least three, at least four, at least five, or at least six cable conductors can be directly connected to each wafer 214 of the upper cable connector 210. However, as shown in FIGS. 20A and 20B, only one twinaxial cable 215 can be directly connected to the wafer 214 of the upper cable connector 210 that is electrically connected to the memory device 240. For example, no twinaxial cables or at least one twinaxial cable can be directly connected to the wafer 214 of the upper cable connector 210 that is electrically connected to the memory device 240. Accordingly, no twinaxial cables can be directly electrically connected to the memory device 240.

The memory module 246 may be implemented as shown in FIG. 11, similar to the implementation of the memory module 146 described above. The resistor R1 and the capacitor C1 shown in FIG. 11 may correspond to one or more of the circuit elements 247 shown in FIG. 21.

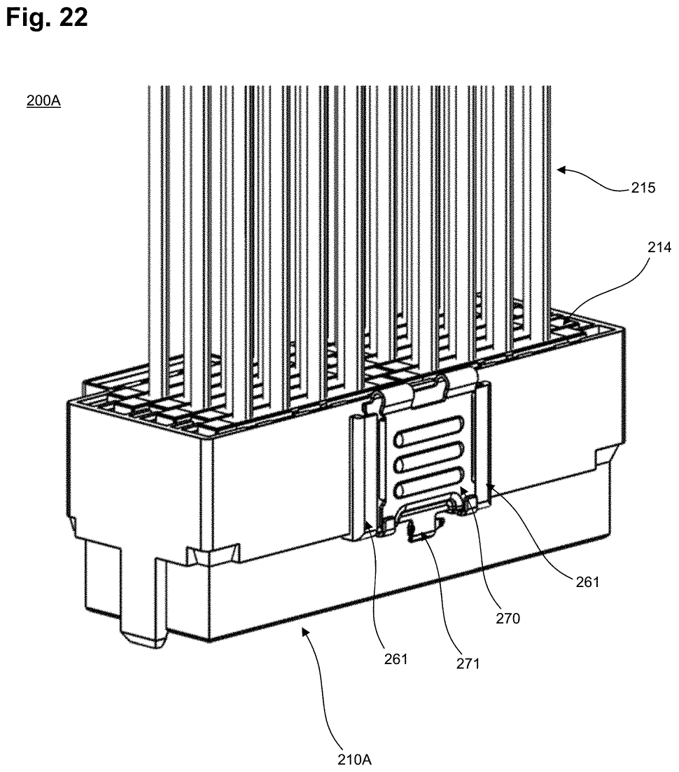

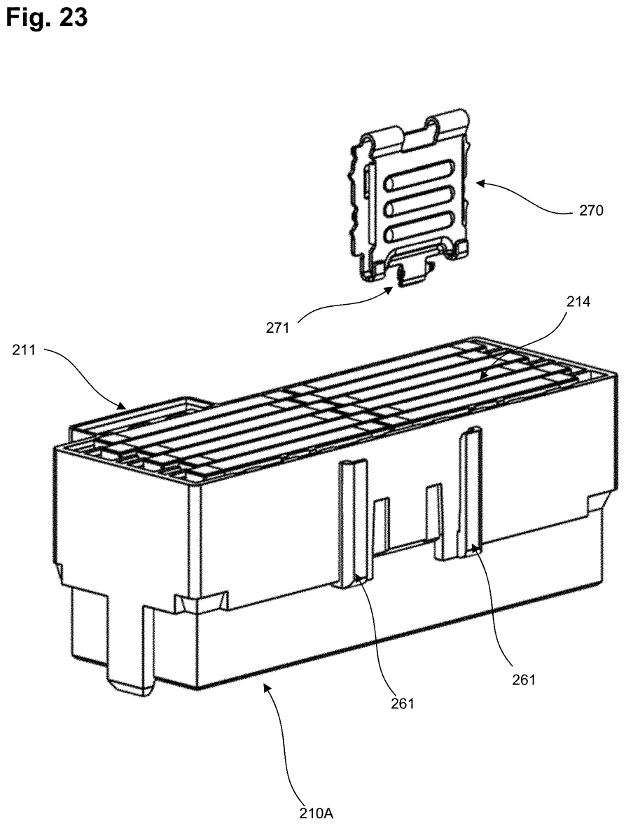

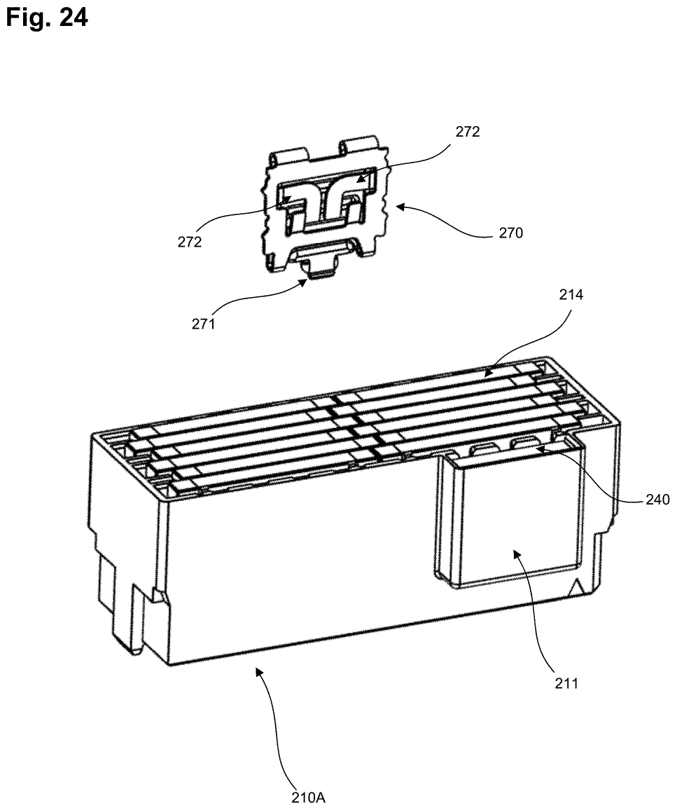

FIGS. 22-24 are perspective views of a modification 200A of the cable connector system 200 with a clip 270 added to secure the upper cable connector 210A to the lower connector 220. As shown in FIGS. 22 and 23, the clip 270 is inserted into brackets 261 provided on an exterior surface of the upper cable connector 210A. As shown in FIG. 24, the clip 270 includes prongs 272 that provide a press fit or friction fit to secure the clip 270 to the upper cable connector 210A. As shown in FIGS. 22 to 24, the clip 270 includes a clasp 271 that mates with a corresponding notch in the lower connector 220 to secure the upper cable connector 210A to the lower connector 220. The clasp 271 may include teeth, protrusions, prongs, or the like that mate with corresponding holes in the lower connector 220. The clip 270 can be provided on a surface of the upper cable connector 210A that is opposite to the exterior surface that includes the pocket 211.

As shown in FIGS. 12-16, the upper cable connector 210 may house a plurality of signal cables 215. For example, each of the upper and lower connectors 210 and 220 may include six rows of signal cables 215 that are separated into two banks, thereby providing 96 separate electrical connections by 48 pairs of twinaxial cables. However, for example, three of the 48 pairs of twinaxial cables can be omitted from the wafer 214 to which the memory device 240 is connected, such that only 45 pairs of twinaxial cables are provided. The pairs of twinaxial cables 215 can be used to transmit signals (for example, data signals and/or clock signals) and/or power. This implementation may provide performance of up to, for example, 112G PAM4 (i.e., a line data rate of 112 Gb/s using pulse amplitude modulation with four levels).

One or more of the cables 215 may be connected to the wafer 214 to which the memory device 240 is connected, and one or more of the cables 215 can provide a pass-through connection with the memory device 240. For example, a cable conductor that provides power to the memory substrate 245 may additionally provide power to another device.

Although twinaxial cables have been described above, other types of cables may be included as the cables 215. For example, coaxial cables, parallel coaxial cables with drain wires, and other types of cables may be directly connected to the memory module 246.

As shown in FIGS. 12-16, 18, 20A, and 20B, a first end of each of the cables 215 of the cable assembly is terminated at the upper cable connector 210. A second end of each of the cables 215 may also be terminated to a similar cable connector. A second memory device may be provided at the second end of the cables 215, in a similar second connector housing of a second upper cable connector as the first connector housing of the upper cable connector 210. The second memory device may include similar connections to a second upper cable connector as the upper cable connector 210 described above. However, if the second memory device is not included, the corresponding contacts in a second upper cable connector (and corresponding lower connector) may be left as not connected or may be connected to ground.

The memory device 240 can be inserted into the upper cable connector 210 after the upper cable connector 210 has been manufactured, or the memory device 240 may be mounted to a wafer 214 of the upper cable connector 210 before the wafer 214 is inserted into the first connector housing of the upper cable connector 210.

Examples of other cable connectors that may be provided at the second end of the cables 215 include an EXAMAX® connector (for example, an EXAMAX® Backplane Cable Header (e.g., Samtec, Inc. series number EBCM)); a NOVARAY two-bank four row cable connector (for example, as shown in EU RCD 005469509-0001, the contents of which are incorporated herein in their entirety); a quad small form factor pluggable (QSFP) connector; an ACCELERATE connector (for example, an 0.635 mm ACCELERATE Slim Cable Assembly (e.g., Samtec, Inc. series number ARC6)); a FLYOVER QSFP (e.g., Samtec, Inc. series number FQSFP) connector (for example, as described in U.S. 2019/0181570 A1, the contents of which are incorporated herein in their entirety); a NVAM® cable connector such as the one shown in U.S. application Ser. No. 29/632,520; a PCIe (peripheral component interconnect express) connector; one of the electrical connectors disclosed in PCT Application No. PCT/US2019/055139, the contents of which are incorporated herein in their entirety; one of the electrical connectors described in U.S. 2019/0267732, the contents of which are incorporated herein in their entirety); or a FIREFLY connector (for example, a FIREFLY copper connector (e.g., Samtec, Inc. series number ECUE).

A cable assembly can include a memory device that is insertable into a first connector housing of an upper cable connector. By providing the memory device that is selectively insertable into a first connector housing of the upper cable connector, the cable assembly is able to be easily implemented in various systems, while also being manufactured with reduced costs. In addition, the memory device can be easily implemented with other types of cables, and existing cabling and connectors can be easily modified to include the memory device.

Thus, an electrical connector can be provided with a memory device, but without requiring a paddle card or transition substrate within the body of the connector (e.g., a transition circuit board).

While embodiments of the present invention have been described above, it is to be understood that variations and modifications will be apparent to those skilled in the art without departing the scope and spirit of the present invention. The scope of the present invention, therefore, is to be determined solely by the following claims.

1. A cable assembly comprising:
a first connector that includes a first connector housing;
at least two connector conductors and at least two signal conductors included in the first connector housing;
at least two connector cable conductors that are each physically connected to a respective one of the at least two connector conductors;
at least two signal cable conductors each physically connected to a respective one of the at least two signal conductors;
a second connector that includes a second connector housing and that is connected to respective ends of the at least two connector cable conductors that are opposite to the ends of the at least two connector cable conductors connected to the first connector;
a substrate; and
a memory module mounted to the substrate, wherein
the substrate and the memory module are both located outside of the first connector housing, are located outside of the second connector housing, are spaced away from the first connector housing, and are spaced away from the second connector housing, and
the at least two signal cable conductors are each physically connected to the substrate.

2. The cable assembly of claim 1, wherein the memory module includes an EEPROM (electronically erasable programmable read-only memory).

3. The cable assembly of claim 1, wherein the at least two signal cable conductors are at least partially surrounded by a ground shield layer.

4. The cable assembly of claim 3, wherein the ground shield layer is directly connected to a ground connection of the substrate.

5. The cable assembly of claim 3, wherein none of the at least two signal cable conductors is electrically connected to ground.

6. The cable assembly of claim 1, wherein the first connector does not include a substrate or a circuit board.

7. The cable assembly of claim 1, wherein the memory module is covered by a housing that is separate from the first connector housing and is spaced away from the second connector housing.

8. The cable assembly of claim 1, wherein the memory module is not physically connected to any of the at least two connector conductors and the at least two signal conductors.

9. The cable assembly of claim 1, wherein the at least two signal cable conductors include at least three signal cable conductors that are each physically attached to the substrate.

10. The cable assembly of claim 1, wherein the at least two signal cable conductors include at least four signal cable conductors that are each physically attached to the substrate.

11. The cable assembly of claim 1, wherein the at least two signal cable conductors include at least five signal cable conductors that are each physically attached to the substrate.

12. The cable assembly of claim 1, wherein the at least two signal cable conductors include at least six signal cable conductors that are each physically attached to the substrate.

13. The cable assembly of claim 1, wherein the memory module is covered with heat-shrink tubing or covered by a sleeve.

14. The cable assembly of claim 1, wherein:
one of the at least two signal cable connectors is a ground conductor, and
the memory module is not physically connected to the ground conductor.

15. The cable assembly of claim 1, wherein each of the at least two signal cable conductors is terminated only at the substrate.

16. A cable assembly comprising:
a first connector including a first contact and a second contact provided in a first connector housing;
a second connector including a first contact and a second contact provided in a second connector housing;
a substrate;
a memory module mounted to the substrate;
a first cable physically connected the first contact of the first connector and physically connected to the first contact of the second connector; and
a second cable physically connected to the second contact of the first connector and physically connected to the substrate, wherein
the substrate and the memory module are both located outside of the first connector housing, located outside of the second connector housing, spaced away from the first connector housing, and spaced away from the second connector housing.

17. The cable assembly of claim 16, wherein the second cable terminates only at the substrate and is not connected to the second contact of the second connector.

18. The cable assembly of claim 16, wherein the first and the second cables are twinaxial cables.

19. The cable assembly of claim 16, further comprising third and fourth cables that are physically connected to the first connector and the substrate.

20. The cable assembly of claim 19, wherein the third and the fourth cables are not connected to the second connector.

21-52. (canceled)
